(19) United States
(12) Patent Application Publication
(10) Pub. No.: US 2008/0290106 A1
(43) Pub. Date: Nov. 27, 2008

(54) Container, Dispenser, and Method For Dispensing a Strip of Interconnected, Individually Packed Objects

(75) Inventors: Guido Petrus Johannes van der Klaauw, Hilversum (NL); Bartel Antonius Timmermans, Den Haag (NL); Matheus Joseph van Nuenen, Haarlem (NL)

Correspondence Address: YOUNG & THOMPSON, 209 Madison Street, Suite 500, ALEXANDRIA, VA, 22314, US

(73) Assignee: INNOSPENSE CAPITAL B.V., DEN HAAG (NL)

(21) Appl. No.: 12/096,429

(22) PCT Filed: Dec. 5, 2006
(86) PCT No.: PCT/NL2006/050305

§ 371 Date: Aug. 6, 2008

(30) Foreign Application Priority Data
Dec. 6, 2005 (NL) 1030603
Sep. 21, 2006 (NL) 2000243

(51) Int. Cl. G07F 11/66

(52) U.S. Cl. 221/1; 221/25

(57) ABSTRACT

Container for dispensing by the piece a strip of interconnected pouch-shaped packs, in particular packs of medicines, vitamins and/or dietary supplements, which strip is accommodated in meandering fashion in the container, which container comprises a bottom with two longitudinal walls and two side walls, characterized in that the container has a width which substantially corresponds to the width of the packs and has a length of at least two interconnected packs.

The invention relates to a container comprising a meandering strip of interconnected packs with individually packed objects, such as vitamins, dietary supplements and/or medicines. The invention also relates to a dispenser suitable for accommodating the container, and to a method for packing and distributing the abovementioned individually packed objects for the purpose of dispensing said objects by the piece.

An assembly of a container and a dispenser for dispensing individually packed medicines by the piece is disclosed in US 2005/0049747. A strip of interconnected packs is packed in a vertical tube, which has to be placed in the dispenser. The packs are guided from the dispenser by a pulling element and are automatically pulled in one or more packs out of the tube, conveyed to a dispensing point and cut off the strip. Removing the packs from the tube and guiding said packs to the dispensing rollers of the known device is relatively complex. Furthermore, the strip of packs is removed from the tube halfway up the height of the tube, which can make the guidance problematical, and can result in the packs becoming jammed. This means that the known device can be filled only by a technically trained user, and filling takes a relatively long time, in view of the care which has to be taken to guide the strip of pouch-shaped packs through the device.

It is an object of the invention to provide a container with individually packed objects, in particular vitamins, dietary supplements and/or medicines, in which packing, conveyance and dispensing of the packs by the piece can be performed simply, cost-effectively and relatively quickly. Dispensing “by the piece” as the phrase is used here means the dispensing of one or more packs from the container, with the packs which are not dispensed remaining behind in the container for subsequent dispensing.

It is also an object of the invention to provide a dispenser in which the container can be placed easily, in particular by technically untrained and/or older users.

It is a further object to provide a container and a dispenser in which the dispensing can be performed without problems, and in which jamming is prevented.

Finally, it is an object to provide a container containing a strip of individually packed objects, in which the strip can be dispensed from the container in a precisely defined manner by exerting a slight force. It is also an object to provide a container which can be filled easily with a strip of individually packed objects and can be hermetically and hygienically sealed by techniques which are known per se, while said container can be opened easily by the user.

To this end, the container according to the invention has a width which substantially corresponds to the width of the packs and a length of at least two interconnected packs.

Placing the strip of packs in meandering fashion in the elongated container, so that said strip can be pulled out of the container over a side wall of the container ensures that a hygienic and, where necessary, sterile pack with a defined quantity of products is obtained in a simple manner by packing techniques which are known per se. It has been found that the meandering strip of individual packs, which is placed in the container in loops with a length of two or more packs, opens out in a problem-free manner when the strip of packs is pulled with a relatively slight pulling force over a side wall of the container. The packs are aligned and guided here by the sliding retention of the longitudinal edges of the strip between the longitudinal walls of the container. This guidance has been found advantageous in particular if at least one of the longitudinal edges of the strip comprises a reinforcement edge, for example in the form of a sealing seam or sealing strip.

In the sealed state said container forms a readily stackable unit which can be transported in bulk packs, and which is easy to open at the place of use, even by older users. This makes the container especially suitable for use for medicine distribution and dosing in care homes for the elderly and the chronically ill, and for the elderly and the chronically ill living at home. The containers are easy and quick for the nursing staff to distribute among the users, and can subsequently be made ready for dispensing by the staff or by the end user.

The container is preferably provided near a side wall with a guide element for guiding the packs over the side wall. Said guide element can be formed by, for example, a groove in a lid of the container, it can be an integral lip formed on the side wall of the container, or it can be a part of a dispenser in which the container can be accommodated as a refill cartridge.

After filling of the container with the meandering strip of packs, said container is covered along an upper surface by of a removable covering element. The covering element can comprise a film made of plastic, paper, metal or a laminate of these, which covering element is glued or heat-sealed over the container. It is also possible to cover the container with a removable lid which grips in a clamping manner over the walls of the container, as in the case of lids known per se for packs for foods. The lid can be sealed over the container, the container itself being covered by a film or left as it is. Through this seal, correct and predefined contents of the container are guaranteed and any change made in said contents after packing can be detected.

If the covering element comprises a removable lid, the latter can be provided with a dispensing aperture on a transverse side. Said aperture can be sealed by a removable film prior to use. A cutting element, such as teeth or a cutting edge, for cutting off the packs can be provided near the dispensing aperture. The lid can be of a non-reusable type and can be offered to the consumer each time with the container. It is, however, also possible to make the lid reusable, and to offer only a sealed container to the user, in which case the packs can be dispensed after removal of the seal and placing of the lid. Dispensing aids, such as a dispensing roller, a cutting element or teeth and the like, can be integral with the reusable lid.

An advantageous embodiment of a container according to the invention is obtained by guiding an end part of the strip of packs through an aperture to the outside of the container, so that said end part can be gripped by a user. The first pack, for example, can be empty and can be guided through a slit in the lid and can be connected by, for example, adhesive or adhesive tape to an outer side of the lid. The user can start dispensing the packs without having to remove the lid. It is also possible to connect a pulling element, such as a flexible lip, to the first pack and to guide said lip by way of a dispensing slit in the lid or in a side wall to the outside of the container, and to connect said lip in a sealing manner to the container.

In a further embodiment of a container according to the invention the longitudinal walls and the side walls are provided on an upper side with a transverse edge of a predetermined width. Said transverse edge, which is known per se from trays for packing food products, can advantageously be connected to a film. It is furthermore possible for the transverse edge to interact with a lid which is provided with a circumferential edge gripping around the transverse edge. The lid can be connected to the transverse edge in a clamping fit in a simple manner, and is easy to remove.

Furthermore, in a further embodiment the transverse edge can form a gripping edge for connection to a dispenser in which the container is accommodated. The averse edge makes it possible in a simple manner to position and/or fix the container on the dispenser in a clearly defined dispensing position. The dispenser can comprise a pulling element which interacts with the longitudinal edges of the strip of packs, and also a guide element. In one embodiment the guide element of the dispenser comprises a hook-shaped lip which grips around the transverse edge of the container. Connecting the transverse edge of the opened container to the guide element results in the container being fixed in the dispenser by a simple action, and the strip of packs can be supplied in a trouble-free manner to the pulling element of the dispenser.

The present invention also provides a method for dispensing individually packed objects, in particular medicines, vitamins and/or dietary supplements, comprising the steps of:

packing medicines in a strip of interconnected pouch-shaped packs,

placing the strip in meandering fashion in a container having a bottom with two longitudinal walls and two side walls, which container has a width which substantially corresponds to the width of the packs and a length of at least two interconnected packs,

sealing an upper surface of the container, and

transporting the sealed containers to a dispensing location.

The objects to be dispensed by the piece are individually packed in strips of interconnected pouch-shaped packs in a manner which is known per se, such as by means of a flow-wrap device. Predetermined quantities (doses) of the packs, in loops of at least two packs one behind the other, are then placed loose in the elongated containers in stacks which are, for example, between two and twenty layers thick. The packs here are retained laterally between the longitudinal walls of the container. The filled containers are provided with a film seal and/or a lid. An advantageous container for using the process is obtained by, for example, a tray which is known per se and lid such as that used for food products.

The filled and sealed containers can be stacked and packed in bulk packs, for example in boxes or in shrink film, and can be distributed by way of a distribution centre to the users, such as users in nursing homes or hospitals, or users at home. The containers can then be removed from the bulk pack and distributed among the end users, where they are opened and placed in the configuration for dispensing by the piece (i.e. dispensing of one, two or more packs) for a specific period (for example a predetermined number of days, a week, or a month). The method according to the invention makes it possible to deliver medicines, vitamins and/or dietary supplements in defined quantities and of guaranteed quality directly from the manufacturer to the end user.

A number of embodiments of a container and a dispenser according to the invention will be explained in greater detail with reference to the appended drawing, in which:

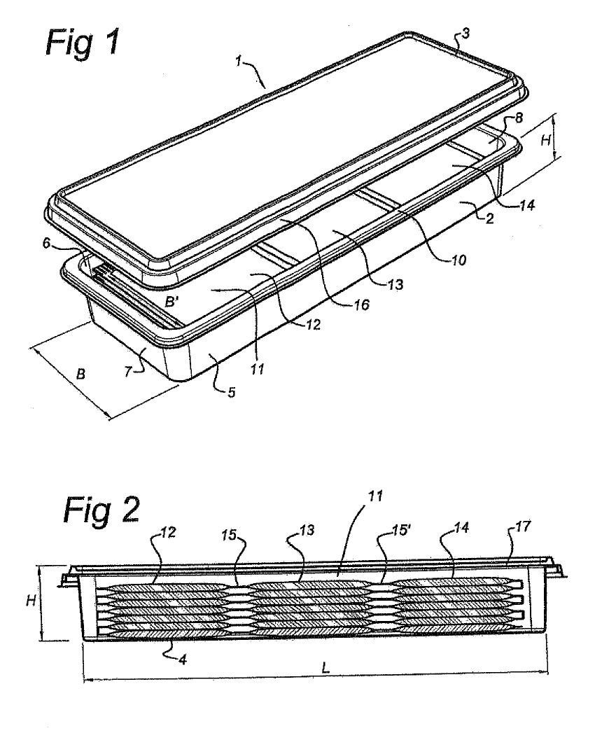

FIG. 1 shows a perspective view of a disposable container and lid, for use as a refill cartridge for a dispenser;

FIG. 2 shows a longitudinal section of the container of FIG. 1;

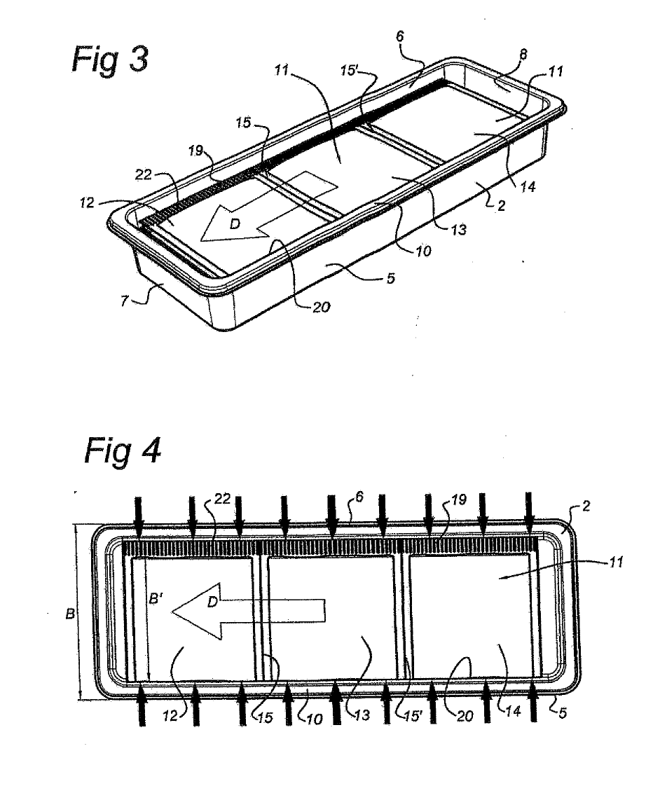

FIG. 3 shows a perspective diagrammatic view of the guiding action of the longitudinal walls of the container on the strip of packs;

FIG. 4 shows a top view of the container according to FIG. 3;

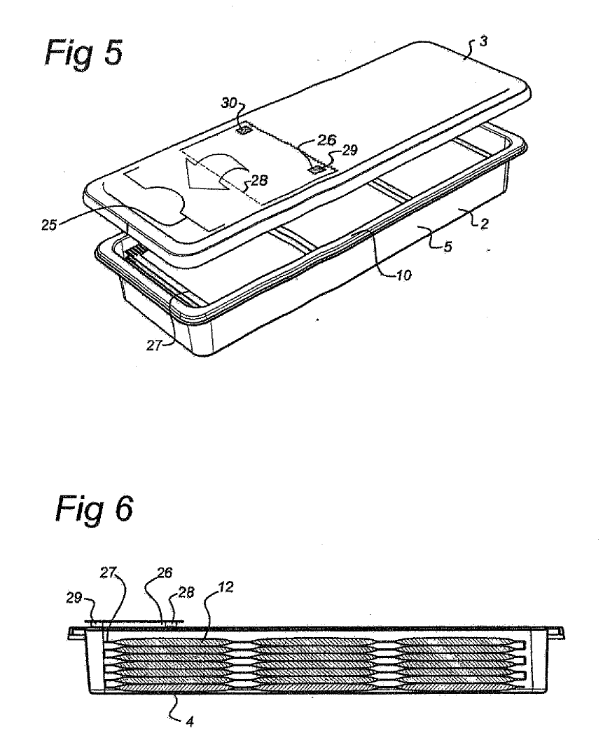

FIG. 5 shows a perspective view of a container with a lid with dispensing means;

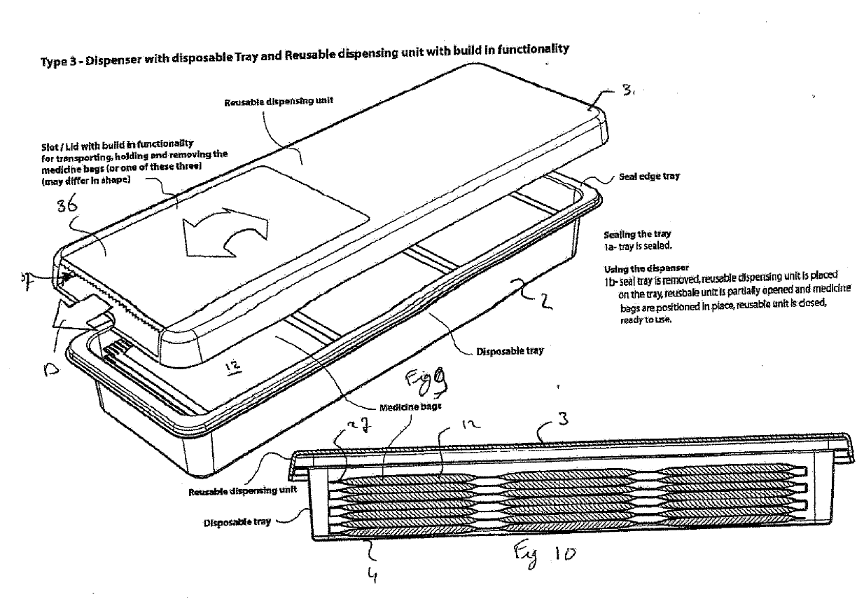

FIG. 6 shows a longitudinal section of the container according to FIG. 5;

FIG. 7 shows a perspective view of the container according to FIG. 5, with the dispensing means in the working position;

FIG. 8 shows a longitudinal section of a container with pulling element fixed on the packs;

FIG. 9 shows a perspective view of a container suitable for a single use, with a reusable lid which is provided with dispensing means;

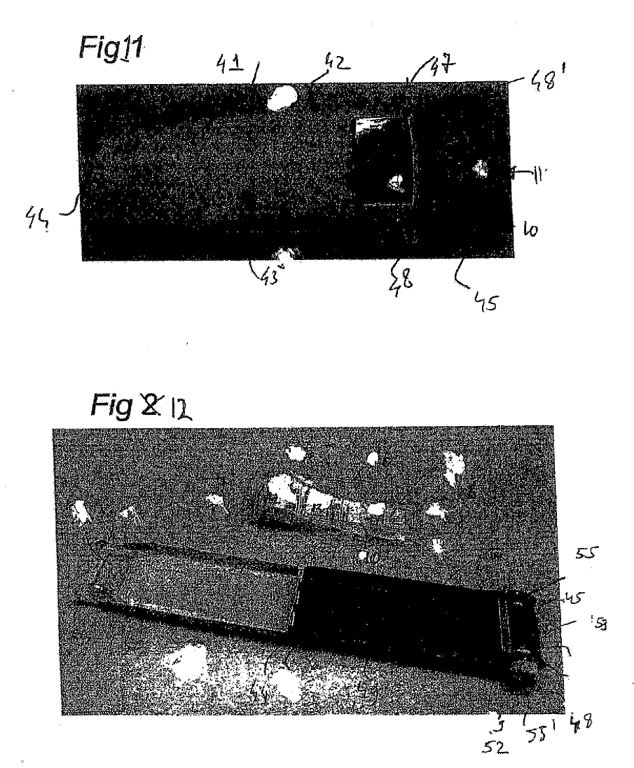

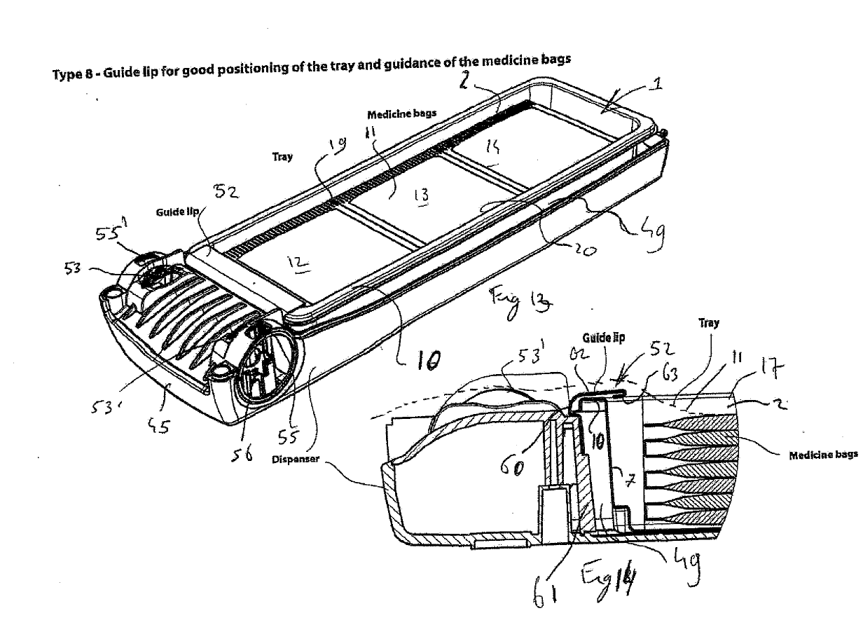

FIG. 10 shows a longitudinal section of the container and lid according to FIG. 9;

FIG. 11 shows a top view of an assembly of a dispenser and a container according to the invention;

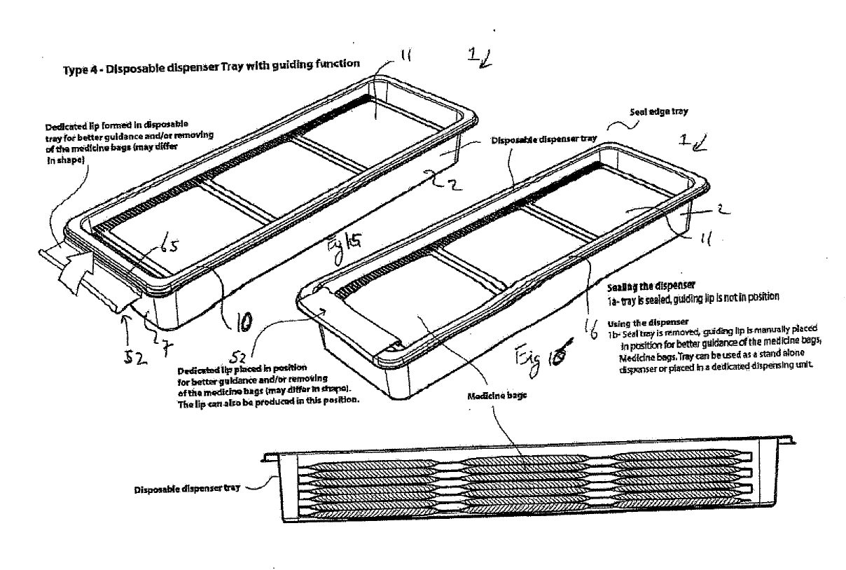

FIG. 12 shows a perspective view of the assembly according to FIG. 11;

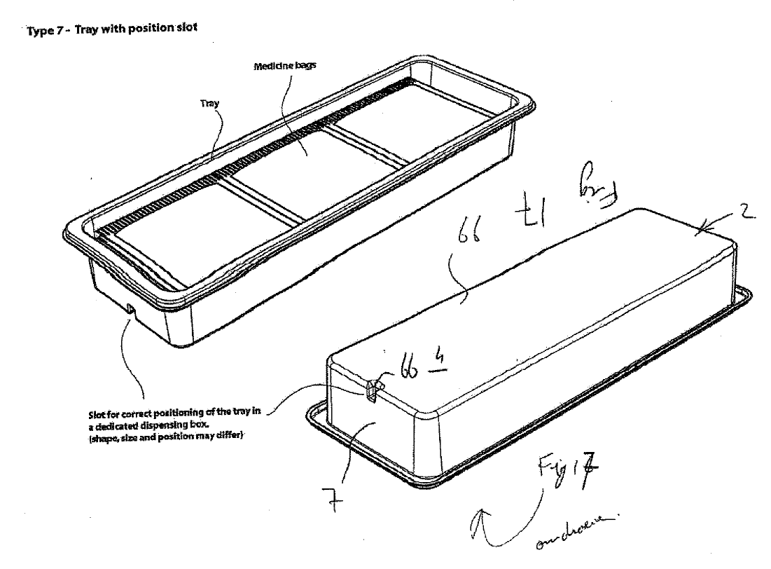

FIG. 13 shows a perspective view on an enlarged scale of an assembly and container;

FIG. 14 shows a longitudinal section of the guide element of the assembly of the dispenser according to FIG. 13;

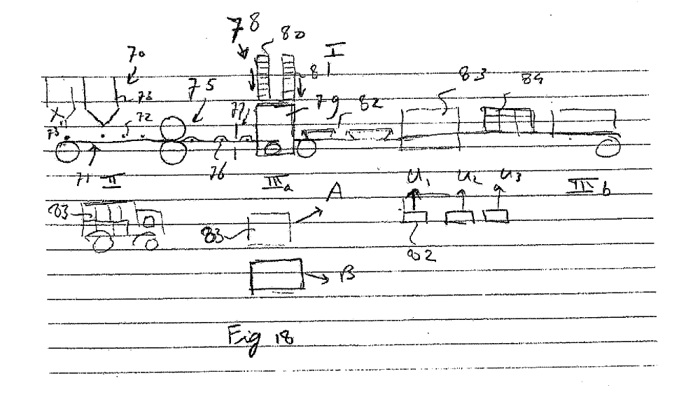

FIG. 15 shows a container provided with a guide element in a transport position;

FIG. 16 shows the container according to FIG. 15 with the guide element in the working position;

FIG. 17 shows a perspective bottom view of a container provided with a positioning hollow;

FIG. 18 shows a diagrammatic overview of production, packing, transport and distribution of medicines according to the invention;

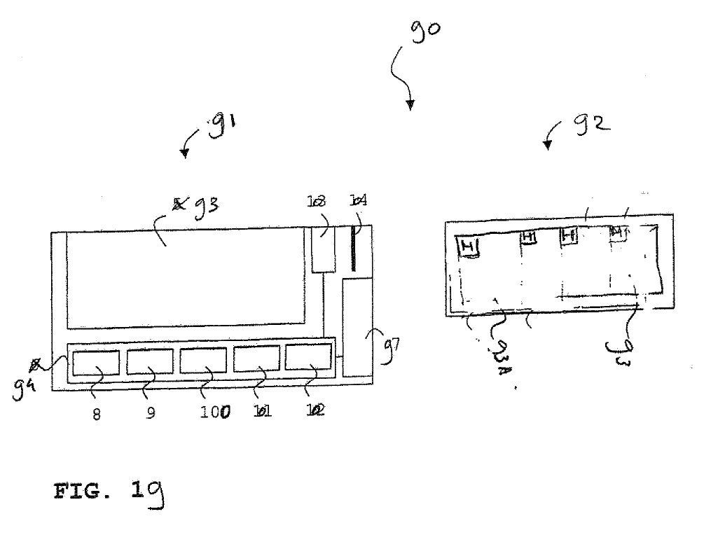

FIG. 19 shows an assembly of the container and an electronic dispenser according to the invention; and

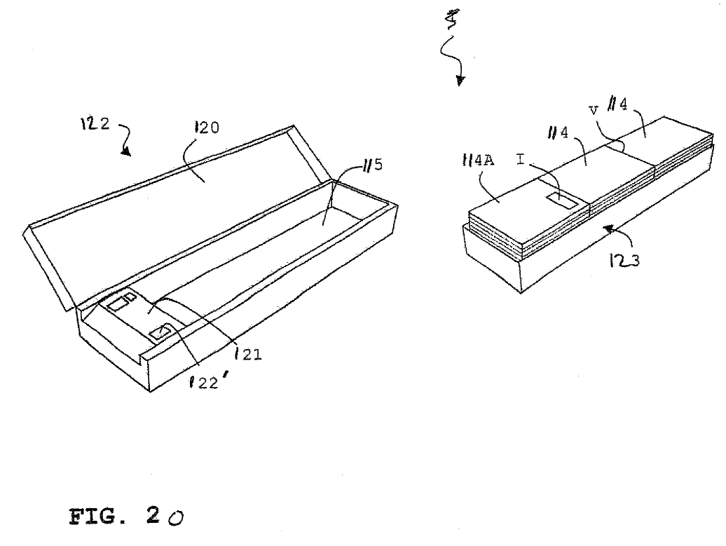

FIGS. 20-22 show a diagrammatic view of the filling of an alternative dispenser according to the invention.

FIG. 1 shows a container 1 with an elongated tray 2 and a lid 3. The tray 2 comprises a bottom 4, two longitudinal walls 5, 6 and two side walls 7, 8. The walls 5, 6, 7, 8 are provided with a transverse edge 10 on an upper side. A strip 11 of interconnected packs 12, 13, 14 is accommodated in the tray 2, which strip is placed loose in a looped bundle in the tray 2. The packs 12, 13, 14 are interconnected by way of fold lines or tear lines 15, 15′. The length L of the tray 2 corresponds to three packs 12, 13, 14 situated one behind the other. The internal width B of the tray 2 corresponds to the width B′ of the packs 12, 13, 14. The height H of the tray 2 is such that in this example seven layers of stacked packs are accommodated in the tray. The lid 3 is connected to the transverse wall 10 in a tight fit by way of a receiving edge 16. A film which is connected to the transverse wall can be provided over an upper surface 17 of the tray 2. It is also possible to connect the lid 3 in a sealing manner to the transverse edge 10. The tray 2 and the lid 3 are made of relatively thin material suitable for a single use, for example polyethylene of a thickness of 0.5 mm or less.

After removal of the lid 3—and the covering film, if present—the tray 2 containing the packs 12, 13, 14 can be placed in a dispenser of the type shown in FIGS. 11-14 or FIGS. 19-22, or a lid of the type shown in FIGS. 9 and 10 can be placed over the tray, in order to dispense the packs 12-14 by the piece. The packs 12-14 are pulled here by way of a front pack in the longitudinal direction of the tray 2 over the side wall 7 or 8 in the direction of the arrow D, as shown in FIG. 3, until the desired quantity of packs 12-14 has been dispensed from the tray.

In the process the strip 12-14 is unwound. The longitudinal edges 19, 20 of the strip 11 are guided here by the longitudinal walls 5, 6 of the tray 2, so that a uniform unwinding of the meandering strip 11 is obtained when a relatively slight pulling force is exerted upon the front pack 12 in the direction of the arrow D. The internal width B of the tray 2 is no more than 5 mm greater than the width B′ of the packs here. In the example shown the width B of the tray 2 and the width B′ of the packs substantially correspond, so that a sliding retention of the longitudinal edges between the longitudinal walls 5, 6 of the tray 2 is obtained. The sealing edge 22 of the strip 11 here forms a reinforcement strip which helps with the guidance and can be gripped by a pulling element of a dispenser on the sealing edge 22 in order to exert a pulling force upon the packs 12, 13 14 in the direction of the arrow D.

In the embodiment according to FIG. 5 a dispensing element with a slit 25 and a cutting and covering element 26 is connected to the lid 3. In the transport state shown in FIG. 6 the element 26 covers the slit 25 and is connected by adhesive 29, 30 to the lid. The tray 2 is taken into the dispensing position from the storage and transport position shown in FIG. 6 by removing the adhesive 29, 30 and folding cutting/covering element 26 around the connecting line 28. The lid 3 is removed from the tray 2 and a transverse side 27 of the front pack 12 is pushed through the slit 25, so that said transverse side is situated on an outer side of the lid 3. The cutting/covering element 26 is then connected again to the lid 3 by way of the adhesive 29, 30, and the lid is replaced on the tray 2, as shown in FIG. 7.

The user can pull the front pack 12 out of the tray 2 by the transverse side 27 extending through the slit 25, taking it underneath the element 26 in the direction of the arrow D, and an individual pack 12 with its tear line 15 along the teeth of the cutting/covering element 26 can be cut off the strip 11 of interconnected packs.

In the embodiment shown in FIG. 8 the front pack 12 is connected at its transverse edge 27 to a pulling lip 31 which extends by way of the slit 25 in the lid 3 to the outside of the container 2. By means of adhesive 32, 33, the pulling lip 21 is connected in a sealing manner to the lid 3, in such a way that the slit 25 is hermetically sealed and access to the inside of the container is closed off. The user can easily remove the first pack 12 from the container 1 without having to remove the lid 3, by breaking the seal formed by the adhesive 32, 33 and by pulling the pack 12 by way of the pulling lip 31 through the slit 25.

FIGS. 9 and 10 show an embodiment in which a lid 3 is placed over a container 2 suitable and intended for a single use, which lid is suitable for repeated connection to different containers 2. The lid 3 is provided with a cutting element 36 and a dispensing slit 37 through which the packs 12, 13, 14 can be pulled out of the tray 2 by the user in the direction of the arrow D. After use of all packs 12-14, the lid of the tray 2 is removed and is connected to a new, filled tray 2.

FIG. 12 shows a dispenser 41 with longitudinal sides 42, 43 and transverse sides 44, 45. Situated on the transverse side 45 is a pulling element 47, which can be operated by means of a rotary knob 48 (An indication of a pack to be dispensed, such as a label, number or bar code, is visible through a window 48′.) A container 1 with packs 12, 13, 14 such as that shown in FIG. 1 can be placed in the dispenser 41 after removal of the lid 3 from the tray 2. The strip of interconnected packs 12, 13, 14 is guided out of the dispenser 41 by way of the pulling element 47, which can comprise, for example, a friction roller which acts upon the strip 11. By way of the window 48′, the user can read print on the packs. The user can tear the pack 12 off the strip 11 along the tear line 15 outside the dispenser.

FIG. 12 shows the dispenser 41 in an opened-out state, in which it is ready for accommodating the opened container 1. The dispenser 41 has an accommodation space 49 which can be covered by a lid 50. The lid 50 is connected by way of a hinge 51 on the transverse side 44 to the accommodation space 49. A metal guide element 52 is fitted along the transverse side 45 of the dispenser 41. Furthermore, friction rollers 53 and 53′, driven by the rotary knob 48, are shown. The container 1 with the meandering strip of packs 11 lying in loops stacked on top of each other in the container 1 has longitudinal walls 5, 6 and transverse walls 7, 8, which correspond in length to the length of the longitudinal sides 42, 43 and transverse sides 44, 45 of the accommodation space 49 in such a way that the container 1 fits with some play into the accommodation space 49. After removal of a lid 3 and/or covering film from the tray 2 of the container 1, the container is ready for placing in the accommodation space 49 of the dispenser, the transverse edge 10 of the side wall 8 being brought into engagement with the guide element 52, and the front pack 12 being placed over the guide element on the friction rollers 53 and 53′. The lid 50 is then closed and the dispenser 41 is ready for dispensing, as shown in FIG. 11. On closure of the lid 50, catches 54, 54′ connected to the lid fall into hollows 55, 55′ on the transverse side 45, and said catches are fixed in the hollow by rotation of the knob 48, so that the lid 50 is locked in the closed position.

FIG. 13 shows the container 1 placed in the accommodation space 49, and shows in detail the engagement of the guide element 52 around the transverse edge 10 of the tray 2. Furthermore, hollows 55, 55′ for accommodating the catches 54, 54′ of the lid 50 are shown. By means of a locking mechanism 56, which is operated by the rotary knob 48 (not shown in this figure), the catches are retained in the hollows by engagement with the locking mechanism. In a predetermined position of the rotary knob 48, which is indicated by an arrow on the knob for the user, the catches 54, 54′ in the hollows 55, 55′ are released, so that the lid 50 can be folded back, as shown in FIG. 12. Furthermore, the friction rollers 53, 53′ over which the strip of packs 11 is guided are shown. The friction rollers 53, 53′ are set in rotation by way of the rotary knob 48 and act upon the longitudinal edges 19, 20 of the strip 11 and pull the strip 11 out of the tray 2, in order to dispense the interconnected packs 12, 13, 14 by the piece. The packs 12-14 are pressed here by the lid 50 with slight force against the friction rollers 53, 53′, in order to obtain the necessary grip on the strip 11. The flat strips on the longitudinal edges of the pouch-shaped packs 12, 13, 14, which can contain a sealing strip on one side or on both sides, interact here with the friction rollers 53, 53′. Instead of friction rollers 53, 53′, it is also possible to use cam rollers which interact with perforations in the longitudinal edges of the pouch-shaped packs, or to use other pulling means to guide the strip outside the dispenser.

FIG. 14 shows how the transverse edge 10 of the tray 2 is retained by the guide element 52. The guide element 52 has an end wall 60 which is fixed to a transverse wall 61 of the accommodation space 49. A sliding surface 62 extends substantially parallel to an upper surface 17 of the container 1, over the transverse edge 10, and a retaining edge 63 of the guide element 52 grips behind the transverse edge 10. The end wall 60, the sliding surface 62 and the retaining edge 63 form an accommodation edge with a width substantially corresponding to the width of the transverse edge 10, which is retained with some play in the accommodation edge. This means that the container 1 is fixed correctly in the accommodation space 47 in a manner which is easy for the user to fit. Furthermore, as indicated by the broken line, the strip 11 is guided over the sliding surface 62 to the friction rollers 53, 53′, so that the meandering strip 11 can be unfolded evenly with slight pulling force and guided out of the tray 2, without the strip becoming jammed.

Although the invention is described with reference to a manually operated pulling element 47, it is also possible to arrange for the friction rollers 55, 55′ to be driven by means of an electric motor, which cuts out after one or more packs 12-14 have been dispensed.

In the embodiment according to FIG. 15 the guide element 52 is fixed on the transverse edge 10 of the side wall 7 of the container 1, for example by forming said guide element integrally with the tray 2 and connecting it to the transverse edge 10 by way of a film hinge 65. The guide element 52 is taken into the working position by folding it around the film hinge 65, as shown in FIG. 16. The container 1 can then be placed in a dispenser, or a lid, for example of the type shown in FIG. 5, can be placed over the tray 2. The guide element 52 has no connecting function for fixing the container 1 here, but serves solely to guide the unfolding of the meandering strip of packs and gradual and even dispensing of said strip of packs from the tray 2.

FIG. 17 shows an embodiment in which the tray 2 is provided with a positioning hollow 66, for example on the bottom 4 and on the side wall 7, which hollow interacts with a corresponding lug in the accommodation space 49 of the dispenser 41 to provide clear positioning of the tray in the dispenser. This prevents the tray from being placed in the dispenser in the direction opposite to that of the unwinding direction of the meandering strip of packs 11, and improves the ease of use and reliability for older users in particular.

FIG. 18 shows the successive steps I, II, IIIa and IIIb for forming a strip of interconnected individually packed medicines, dietary supplements or vitamins, packing the strips in containers, sealing the containers, bundling and transport to dispensing location, and distribution to the end user. In production step I in a filling station 70 a web of film material 71 is provided with medicines 72 by way of a dosing device 73, 73′. The web 71 is fed to a flow wrap station 75, where the film is sealed in a pouch shape around the medicines 72 to form a strip of interconnected packs 76. Said strip is cut off at a predetermined length in a cutting device 77 and is fed to a packing unit 78. The strip is cut off by the cutting device 77 on the basis of a desired total dose for an end user for a predetermined period, for example 1 vitamin per day for a week. It is also possible for various dosing devices 73, 73′ to be used in succession, so that the packs successively contain different active substances. The end user can obtain a combination dose by dosing two packs.

In the packing unit 78 the strips of packs are formed into a looped strip of stacked packs which are placed in trays 80. A lid 81 is sealed over the trays 80. The filled containers 82 are fed to a further packing station 83 and packed in boxes 84.

After transport step II, the boxes 83 are distributed in distribution step IIIa among dispensing locations A, B such as nursing homes or hospitals. At the dispensing locations A, B the containers 82 are distributed in distribution step IIIb among the end users U1-U3 for dispensing by the piece of one or more individual packs 76. In this way it is possible to achieve direct distribution from manufacturer (phase I) to the end user U1-U3.

FIG. 19 shows a dispensing assembly 90, also referred to below as assembly 90, comprising a dispenser 91 and a container or cartridge 92. The container 92 comprises the strip of packs 93. The dispenser 91 has a housing 93 for accommodating the container 92 and is designed to dispense the strip of packs 93 by the piece to the user. The assembly 90 preferably works independently of the power mains, for example on batteries.

The dispenser 91 comprises a module 94 for performing various functions and a screen 97 for displaying information to the user of the assembly 90. The module 94 comprises a clock device 98, a signal device 99, a counter device 100, an input unit 101, and a processing unit/memory 102. Furthermore, the dispenser comprises a reader 103 (which is linked to the module 94) and separation means 104. It will be clear that the assembly 90 does not necessarily comprise all these devices and that the devices are not necessarily combined in one module. It will furthermore be clear that the dispenser 91 can also comprise other devices and/or means, such as further visual communication means (e.g. lamps).

The container 92 comprises the strip of packs 93 stacked in a loop shape, which packs can be provided with information I. The information I can be provided in different ways on or in the packs 93, e.g. in the form of a bar code (e.g. I-dimensional or 2-dimensional or in the form of a hologram) or as an RFID tag. More than one information carrier can be provided on the packs 93. This information I can be read by the reader 103 of the dispenser 91. If the information I is identical for each individual pack, it will suffice to provide and/or read the information I once, so that said information I can in principle be printed on only one pack (e.g. the first pack 93a to be dispensed). Furthermore, in combination with the counter functionality of the module 94, the information I on the first pack 93a can comprise information concerning following packs; it can be stored in the memory 102 and displayed on the screen 97 when the pack concerned is dispensed. Moreover, the information I can be provided on the container 92 as well as or instead of on the pack(s) 93, in which case e.g. the dispenser 91 in the housing 93 has means for reading said information. Such an embodiment can be used, e.g., for determining and/or recognizing a certain sequence to be applied for containers 92 to be placed in succession, or for detecting a container 92 when the latter is removed and replaced in the housing 93. It will be clear to the person skilled in the art that various variants for providing and displaying the information I to the user are possible without deviating from the present invention.

As an alternative, information on the packs 93 and/or for the user can be transmitted to the dispenser 91 by inserting an information carrier (not shown), such as a punched card, diskette, CD-ROM, memory stick etc. with information into the input unit 101. In addition, the information can also be transmitted to the dispenser via a communications network. Furthermore, the information can be transmitted wirelessly to the dispenser, e.g. by way of an infrared or Bluetooth connection.

The packs 934 are preferably made of a strip of interconnected packs 93, the strip being folded into parts of two or more complete packs in the container.

The interconnection of the packs 93 into a strip of packs has the advantage that the packs can be filled automatically with, e.g., medicines. In addition, the interconnection facilitates dispensing of the packs by the dispensing unit 91. The separation means 104 of the dispenser 91 can be used to separate one or more packs from the strip. Said means can furthermore ensure that an incision is made in the pack, so that the latter is easy to open.

The container 92 is made of, e.g., plastic or cardboard. The container 92 can be closed when it is filled with the packs 93 and can be partially opened when it is placed in the dispenser, as will be illustrated in FIGS. 20-22.

FIG. 20 shows a dispenser 122 and a container 123 for a dispensing assembly according to a first preferred embodiment of the invention.

The dispenser 122 comprises a lid 120 for opening the housing 105. The dispenser 122 furthermore comprises a surface 121 in which throughput rollers 122′ for conveying the packs 114 are accommodated. The throughput rollers 122′ may possibly comprise a cutting device for cutting into the sides of the packs 114. Sensors for the reader 103 can be situated in e.g. the lid 120 and/or on the surface 121 at the throughput aperture. It will be clear that the lid 120 and the surface 121 determine an aperture which is sufficient for feeding through the packs 114 for dispensing. Furthermore, the lid 120 provides space for folding over the packs 114 when the strip is being conveyed through the dispenser 122.

The container 123 is partially opened, so that the packs 4 (e.g. sealed bags) with medicines are visible. The lid (not shown) of the container 123 can be thrown away. The packs 114 are accommodated in the container 123 as a strip of interconnected packs 114 separated by a fold line V. The packs 114 comprise information I, such as, e.g., the time for dispensing, the medicines concerned etc., which can be read by sensors of the reader 103.

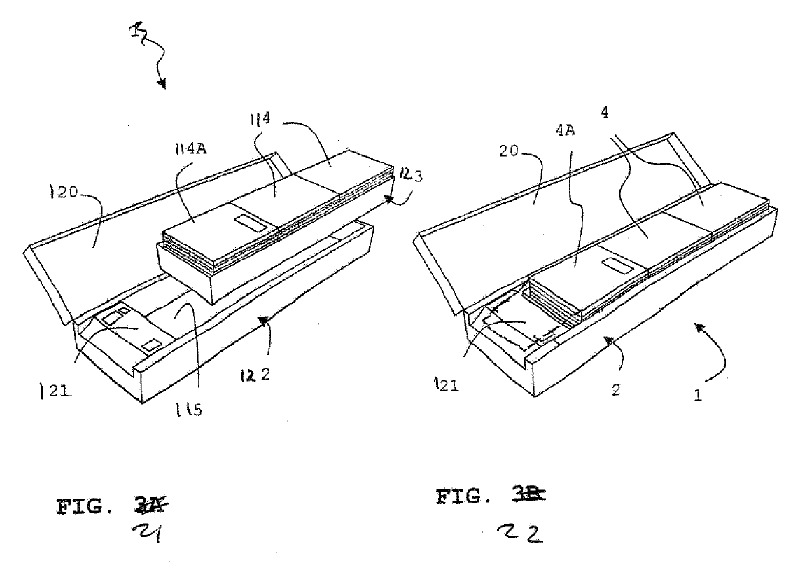

FIGS. 21 and 22 show different steps for assembling and putting into use a dispensing assembly according to the embodiment shown in FIG. 20.

FIGS. 21 and 22 show that the container 123 with the packs 114 is placed in the housing 115 of the dispenser 122. The container 123 preferably fits exactly in the housing 115. The packs 114 have dimensions of, e.g., 80×70 mm. The dimensions of the total assembly are e.g. 250×80 mm. Prior to the accommodation of the container 123 in the housing 115, the pack 114a to be dispensed first from the strip is folded over the pack 114 to be dispensed fourth from the strip.

After the container 123 has been placed in the housing 115, the first pack 114a can be laid on the surface 121, as indicated by a dotted line shown in FIG. 22. The lid 120 of the dispenser 122 can then be closed, and the assembly is ready for use.

1. Container (1) for dispensing by the piece a strip (11) of interconnected pouch-shaped packs (12,13,14), in particular packs of medicines, vitamins and/or dietary supplements, which strip is accommodated in meandering fashion in the container, which container comprises a bottom (14) having two longitudinal walls (5,6) and two side walls (7,8), the container having a length of at least two interconnected packs, the strip (11) extending in a substantially horizontal length direction in the container, characterised in that the container has a dispensing edge at a top side of a side wall (7,8) the width of the container over substantially the height of the walls (5,6,7,8) substantially corresponding to the width (B′) of the packs, the packs (12,13,14) being freely guided along the longitudinal walls (5,6).

2. Container (1) according to claim 1, in which the packs are interconnected by way of a tear line (15, 15′) and comprise two longitudinal edges (19, 20), on at least one longitudinal edge (19) the packs being provided with a reinforcement strip, and the longitudinal edges (19, 20) being situated at a distance of less than 5 mm, preferably less than 2 mm, from the longitudinal walls (5, 6) of the container (11).

3. Container (1) according to claim 2, in which the longitudinal edges (19, 20) of the packs rest substantially against the longitudinal walls (5, 6) of the container.

4. Container (1) according to claim 1, in which near a side wall (7, 8) the container is provided with a guide element (25, 52) for guiding the packs over the side wall (7, 8).

5. Container (1) according to claim 1, in which on an outer side the container is provided with a positioning hollow or positioning lug for acting upon a positioning element of a dispenser in which the container can be accommodated.

6. Container (1) according to claim 1, in which the container comprises an upper surface (17) which is covered by a removable covering element (3).

7. Container (1) according to claim 6, in which the covering element comprises a removable lid (3) with a dispensing aperture (25, 37) on a transverse side.

8. Container (1) according to claim 7, in which the dispensing aperture is provided with a cutting element (26, 36) for cutting off the packs.

9. Container (1) according to claim 7, in which an initial pack (12) comes out of the container directly or by way of a pulling element (31) through the aperture (25, 37) and can be gripped by a user.

10. Container (1) according to claim 7, in which the container is covered with a film.

11. Container (1) according to claim 7, in which the lid (3) is connected to the container by way of a removable seal.

12. Container (1) according to claim 1, in which the longitudinal walls and the side walls (5, 6, 7, 8) are provided on an upper side with a transverse edge (10) of a predetermined width.

13. Container according to claim 12, in which the lid (3) is provided with a circumferential edge (16) which grips around the transverse edge (10).

14. Dispenser (41, 91) for accommodating a container (1) according to claim 1, in which the dispenser has an elongated accommodation space (49, 93) for the container, said accommodation space having on a transverse side (45) a pulling element (53, 53′) for acting upon the longitudinal edges (19, 20) of the packs.

15. Dispenser (41) according to claim 14, in which along the transverse side, near the pulling element (53, 53′), the dispenser is provided with a guide element which can be positioned over a side wall (7, 8) of a container (1) placed in the accommodation space (49, 93).

16. Dispenser (41) according to claim 15, in which the guide element (55) is hook-shaped with an end wall (61), a sliding surface (62) connected to said end wall, and a retaining edge (63) situated transversely to the sliding surface, and in which an upper side of a side wall (9) of a container (1) placed in the accommodation space can be positioned between the end wall (61) and the retaining edge (63).

17. Dispenser (41) according to claim 14, comprising an elongated box with a lid (50).

18. Dispenser (41) according to claim 17, in which near the pulling element (53, 53′) the lid (50) is provided with reading means (48′) for determining an indication on a pack situated near the pulling element.

19. Dispenser (41,91) for accommodating a strip of interconnected pouch-shaped packs (12,13,14), the strip having a width (B′) and longitudinal edges (19,20), the dispenser comprising an elongated accommodation space (49,93) in which the strip can be accommodated in a meandering fashion in a substantially horizontal length direction of the strip, the accommodation space (49,93) being defined by two longitudinal sides (42,43) having a length corresponding to at least two interconnected packs, and two transverse sides (44,45) having a width corresponding to the width (B′) of the strip, a pulling element (48,53,53′) being situated near a top of a transverse side (45) for acting on the longitudinal edges (19,20) of the strip and for exerting a pulling force on the strip in a dispensing direction that is substantially in the direction of the longitudinal edges, a supporting surface being provided near the top of the transverse side (45) extending from a transverse wall (61) of the accommodation space (49,93), substantially in the dispensing direction for supporting a pack during dispensing, at least two upstanding guide elements extending transversely from the supporting surface, near the transverse wall (61) and having a mutual distance corresponding to the width (B′) for aligning the strip with the dispensing direction upon dispensing by contacting the longitudinal edges (19,20).

20. Dispenser (41,91) according to claim 19, the pulling device comprising two rotatable roller members (53,53′) each roller member being situated near a respective upstanding guide element.

21. Dispenser (41,91) according to claim 20, the roller members (53,53′) being operable by a rotatable drive member (48).

22. Dispenser (41,91) according to claim 19, wherein the accommodation space is adapted for receiving a longitudinal container (1) in which the strip of interconnected pouch-shaped packs (12,13,14) is situated, the dispenser having a hook-shaped guide element (52) with an end wall (60) fixed to the transverse wall (61) of the accommodation space (49), a sliding surface (62) connected to said end wall (60), and extending substantially in line with the supporting surface and a retaining edge (63) situated transversely to the sliding surface, and in which an upper side of a side wall (9) of a container (1), when it is placed in the accommodation space, can be received between the end wall (60) and the retaining edge (63).

23. Dispenser (41,91) according to claim 19, the accommodations space being covered by a lid (50) having read-out means (48′) near the pulling element (48,53,53′), for determining an indication on a pack situated near the pulling element.

24. Method for dispensing individually packed objects, in particular medicines, vitamins and/or dietary supplements, comprising the steps of:
packing the objects in a strip of interconnected pouch-shaped packs;
placing the strip in a meandering fashion in a container having a bottom with two longitudinal walls and two side walls, which container has a width which substantially corresponds to the width of the packs and has a length of at least two interconnected packs,
sealing an upper surface of the container,
transporting the sealed container to a dispensing location,
breaking the seal and dispensing the packs by pulling the strip over a dispensing edge at a top side of the side wall of the container.

25. Method according to claim 24, comprising the step of placing the opened container inside a dispenser and guiding the packs along a pulling device on the dispenser.
